(19) United States
(12) Patent Application Publication
(10) Pub. No.: US 2019/0202272 A1
(43) Pub. Date: Jul. 4, 2019

(54) MULTI-LAYER PROTECTIVE WINDOW SYSTEM FOR NON-MILITARY HEAVY EQUIPMENT AND METHOD FOR FABRICATING SAME

(71) Applicant: Tigercat Industries Inc., Brantford (CA)

(72) Inventor: Jonathan Craig COOPER, Brantford (CA)

(73) Assignee: Tigercat Industries Inc., Brantford (CA)

(21) Appl. No.: 16/294,379

(22) Filed: Mar. 6, 2019

Related U.S. Application Data
(63) Continuation of application No. PCT/CA2017/051212, filed on Oct. 12, 2017.
(60) Provisional application No. 62/407,220, filed on Oct. 12, 2016.

(51) Int. Cl. B60J 1/00; E06B 5/10; E06B 7/02; B60J 1/20

(52) U.S. Cl. CPC B60J 1/001; E06B 5/10; E06B 7/02; B60J 1/008; B60J 1/2094; E06B 2007/026; B60J 1/002

(57) ABSTRACT

A protective window system for non-military heavy equipment including: at least two window panes with at least one air gap therebetween wherein the thickness of each window pane and the size of the air gap is determined such that the window system meets or exceeds UL/ANSI 752 level 1 testing. In particular, the panes may be of polycarbonate, formed with a curved shape and between 5 and 30 mm thick. The air gap may be between at least two of the at least two window panes that is between 5 and 50 mm thick. The window system may include a channel for transporting conditioned air and a vent for allowing the conditioned air to enter the air gap; and a hinge mechanism for allowing at least one of the at least two window panes to move in relation to another of the at least two window panes.

### REFERENCE TO RELATED APPLICATION(S)

This document is a formal application based on and claiming the benefit of provisional application No. 62/407,220, filed Oct. 12, 2016, which is hereby incorporated herein by reference.

### FIELD

The embodiments disclosed herein relate to a multi-layer protective window system for non-military heavy equipment and a method for fabricating the same. More particularly, the embodiments herein relate to a protective window for forestry equipment that is intended to protect against chain shot.

### BACKGROUND

Current heavy equipment and, in particular, forestry equipment, includes curved window designs for operators to view the work area in order to operate tools provided to the heavy equipment.

Due to debris and moving equipment in the work environment where heavy equipment is used, impacts on the windows can be fairly common. Impacts on the windows can be a danger to the operators. As such, the windows tend to be quite thick and made from stronger materials such as polycarbonate and the like. In some cases, tempered glass may be used but tempered glass is generally not as strong as polycarbonate and may not be appropriate for various applications.

However, as the material used becomes thicker, it is more and more difficult and costly to form the material into a curved shape for a window. For example, in the forestry industry, curved window designs typically have a maximum 15 mm in total thickness of polycarbonate window because the cost of forming thicker materials is too high.

Further, heavy equipment tends to be used in fairly dirty environments ranging from quite hot to quite cold and this can lead to difficulties in keeping the windows clean and free from frost or condensation.

As such, there is a need for an improved protective window for heavy equipment and, in particular, forestry equipment.

### SUMMARY

According to one aspect herein, there is provided a protective window system for non-military heavy equipment including at least two window panes of transparent material separated by an air gap.

In some cases, the transparent material may be polycarbonate.

In some cases, the thickness of each window pane and the size of the air gap is determined such that the window system meets or exceeds UL/ANSI 752 level 1 testing.

In further cases, each window pane may be between 5 and 30 mm thick. Further, the air gap may be between 5 and 50 mm.

In still further cases, the at least two window panes may include a plurality of window panes.

Further, the air gap may include a plurality of air gaps.

In still further cases, the window system may include a channel for transporting conditioned air and a vent for allowing the conditioned air to enter the air gap.

In yet still further cases, the window system may include a hinge mechanism for allowing at least one of the at least two window panes to move in relation to another of the at least two window panes.

According to another aspect herein, there is provided a method of fabricating a protective window system for non-military heavy equipment, the method including: forming at least two window panes to have a curved shape; mounting a first pane of the at least two window panes on an exterior of a cab of the heavy equipment; mounting another pane of the at least two window panes on an interior of the cab; and providing an air gap between at least two of the at least two panes, wherein at least one of the first pane and another pane are configured to rotate away from the other to allow for cleaning.

In some cases, the thickness of each window pane and the size of the air gap is determined such that the window system meets or exceeds UL/ANSI 752 level 1 testing.

In some cases, each window pane may be between 5 and 30 mm thick.

In further cases, the air gap may be between 5 and 50 mm.

In yet further cases, the at least two window panes may include a plurality of window panes. Further, the air gap may include a plurality of air gaps.

In still yet further cases, the method may include providing a channel for transporting conditioned air and a vent for allowing the conditioned air to enter the air gap.

According to yet another aspect herein, there is provided a protective window system for non-military heavy equipment including: at least two window panes of polycarbonate; an air gap between at least two of the at least two window panes; a channel for transporting conditioned air and a vent for allowing the conditioned air to enter the air gap; and a hinge mechanism for allowing at least one of the at least two window panes to move in relation to another of the at least two window panes, wherein the thickness of each window pane and the size of the air gap can be determined such that the window system meets or exceeds UL/ANSI 752 level 1 testing.

Other aspects and features will become apparent, to those ordinarily skilled in the art, upon review of the following description of some exemplary embodiments.

### BRIEF DESCRIPTION OF THE DRAWINGS

Embodiments will now be described, by way of example only, with reference to the attached drawings, in which:

FIG. 1 shows an embodiment of a protective window system;

FIG. 2 is a side view showing additional detail of a base of the window system of FIG. 1;

FIG. 3 is a perspective view showing additional detail of a base of the window system of FIG. 1, in particular, showing a channel for air flow;

FIG. 4 illustrates a configuration where an interior pane has been moved away from an exterior pane to allow for cleaning of each pane on the sides toward an air gap; and

FIG. 5 shows a detailed view of an embodiment of a top of the window system of FIG. 1.

### DETAILED DESCRIPTION

In many industrial, construction, mining and forestry environments, heavy machinery is operated by users in cabs on the heavy machinery. The cabs typically have windows for the user to be able to see the surrounding environment. However, these environments may have a risk of debris, equipment, materials coming into contact with and damaging the windows and, in some cases, the users. In the particular example of the forestry industry, high powered chain saws are often attached to a boom on a piece of heavy equipment (for example, a harvesting head, processing head, directional felling head, grapple saw or the like). It has recently been determined that when a high powered chain saw has a chain break, the piece of chain that breaks away (called a chain shot) can be directed at the operator cabin (and the window thereof) at very high speeds similar to a 9 mm bullet (1140 ft/sec). It is also believed that the chain shot can be spinning at speeds in the range of 400,000 rpm. Unlike a bullet or other type of projectile, it appears that this high rotational speed can cause the chain shot to penetrate many types of window material even when another type of projectile might not. It is believed that this penetration is due to the friction heat generated when the rotating chain shot first contacts the window material. The friction heat causes melted material that can continue through a pane of, for example, polycarbonate and allow the chain shot to penetrate the window material.

The present document describes embodiments of a window system that is intended to protect against projectiles, including chain shot, by using multiple panes having at least one air gap between adjacent panes. In the present embodiments, the air gap between the panes helps to prevent the melted pool of window material from propagating from a first pane into a second or subsequent panes that is placed after the air gap. In order for the chain shot to penetrate multiple panes, a new heated pool of polycarbonate would need to form in the subsequent pane. However, testing has shown that the rotational energy absorbed in the first pane generally reduces the available energy to melt the material in the second pane.

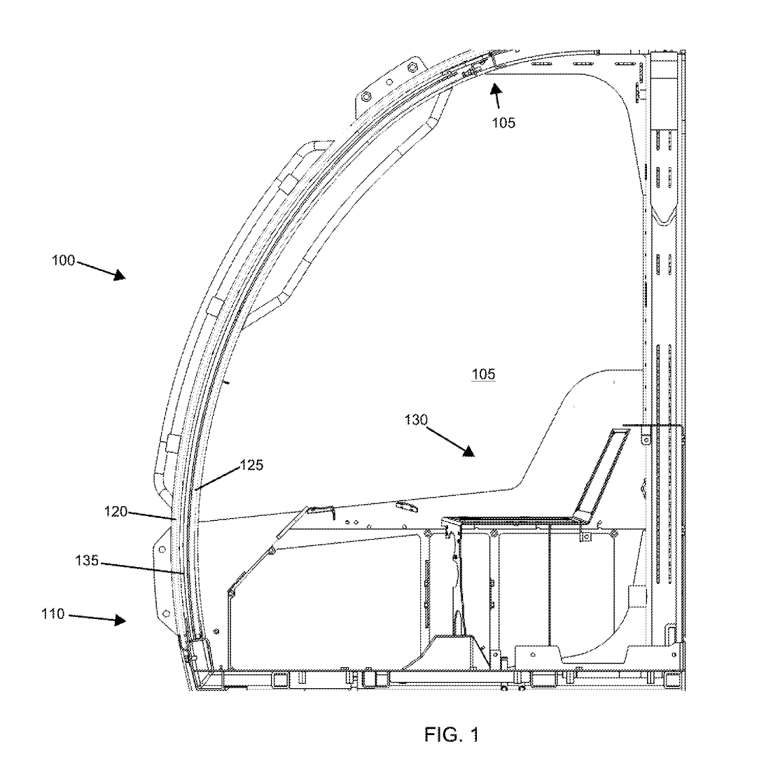

FIG. 1 shows an embodiment of a protective window system 100. The window system 100 curves from top 105 to bottom 110 around an operator cab 115 on a piece of heavy equipment (not shown). The window system 100 could also or alternatively be curved along a horizontal direction. As shown in FIG. 1, the example protective window system includes an exterior pane 120 and an interior pane 125 of transparent material placed adjacent to one another between an operator station 130 and the outside of the cab 115. There is an air gap 135 provided between the exterior and interior windows panes 120, 125. In other embodiments, there may also be additional panes (not shown) between the exterior and interior window panes 120, 125, with appropriate air gaps (not shown) therebetween.

The transparent window material will generally be polycarbonate or similar but could also be other suitable materials having similar functionality.

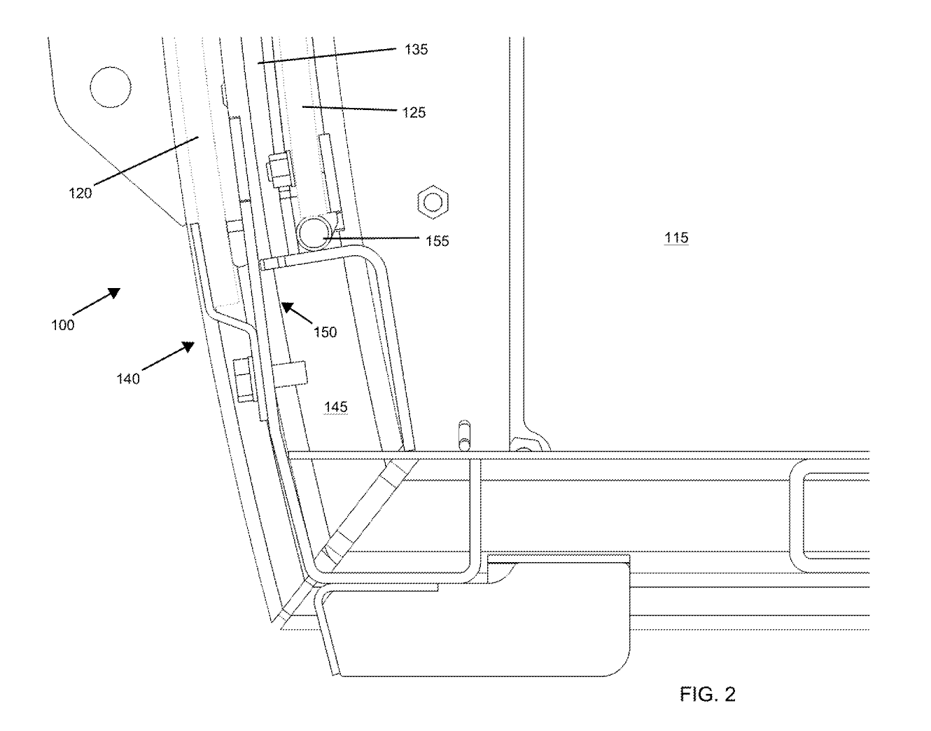

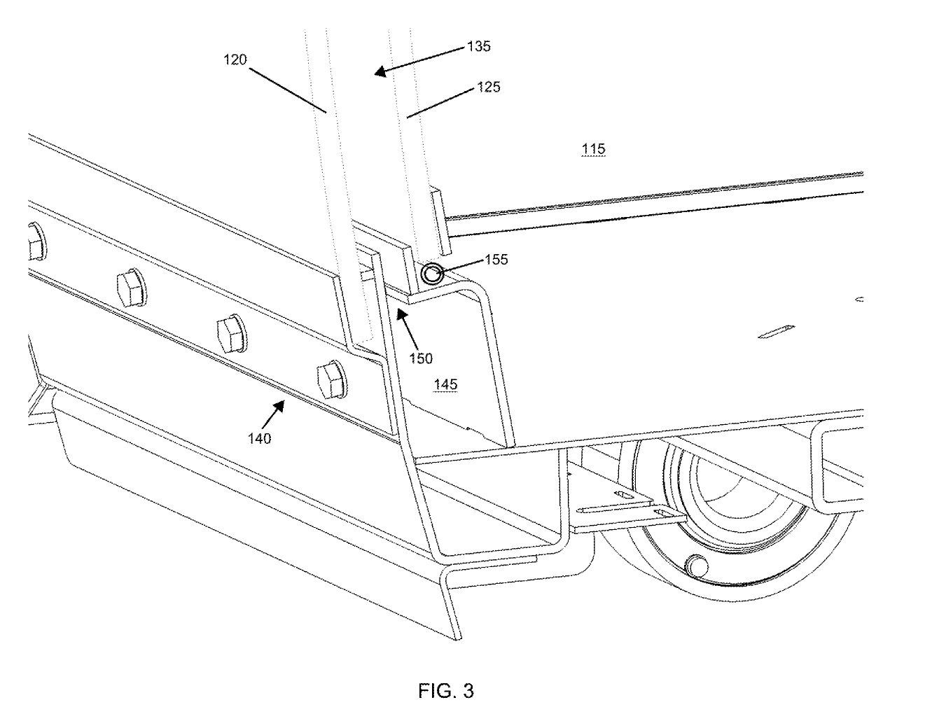

FIGS. 2 and 3 are views showing additional detail of a base 140 of the window system 100. In FIG. 3, some elements have been removed/simplified. FIG. 2 is a side view and FIG. 3 is a perspective view illustrating a channel 145 through which conditioned air can move below the window panes 120, 125. The channel 145 also includes an opening or vent 150 through which conditioned air enters the air gap 135 between the panes 120, 125. As such, the conditioned air (heated or cooled) can be directed between the panes 120, 125 to defrost the panes 120, 125 in colder climates or prevent condensation in hotter climates. The panes 120, 125 of the window system 100 can be thinner than a monolithic single pane, thereby allowing the heated air to more quickly defrost the multiple panes because thinner material is less insulating than thicker material and conducts heat more quickly.

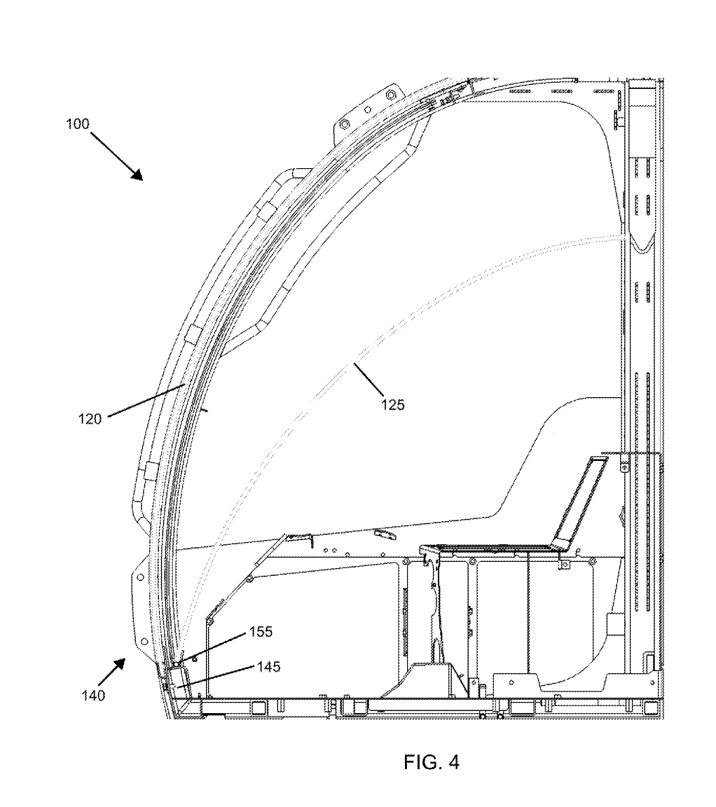

As shown in FIGS. 2 and 3, the window system 100 also includes a hinge 155 to allow one or more of the panes to rotate in relation to the other panes. In the embodiment shown in FIGS. 2 and 3, the hinge 155 is at the lower edge of the interior pane 125. The use of a hinge 155 to mount the interior pane 125 (although either one of the window panes could be hinged) allows access so that the inner sides of the panes may be cleaned more easily. In particular, the hinge 155 on the interior pane 125 allows the interior pane 125 to be moved away from the exterior pane 120 to provide access for cleaning tools to be used to clean between the two panes 120, 125. FIG. 4 is an illustration of the interior pane 125 rotated away from the exterior pane 120 to allow for cleaning of each pane on the sides toward the air gap 135.

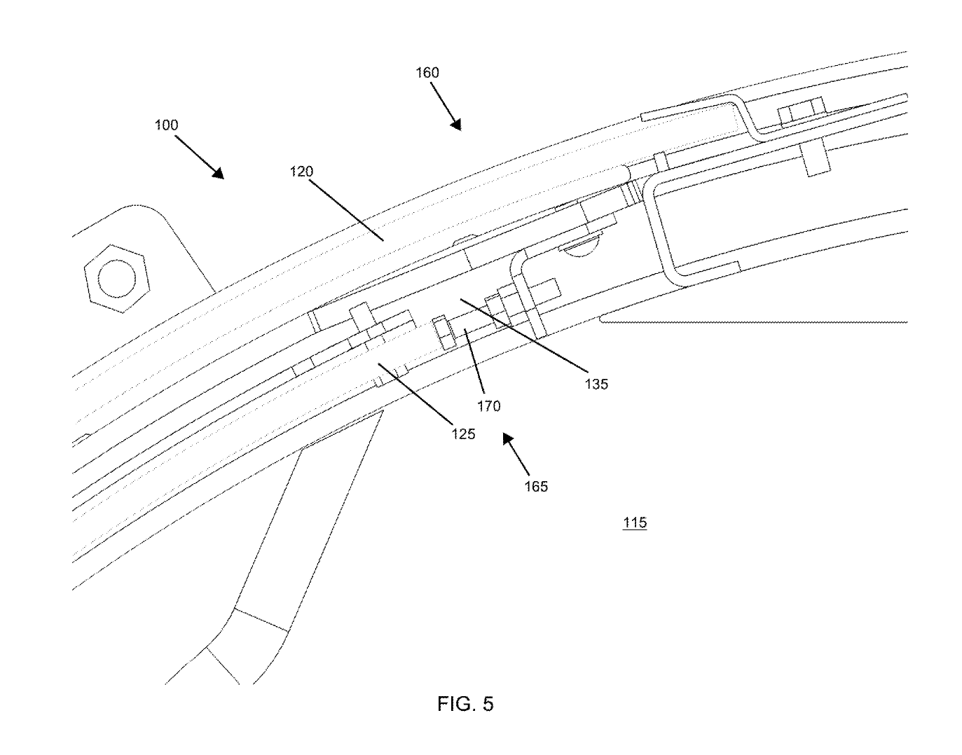

FIG. 5 shows a detailed view of the top 160 of the window system 100. In this embodiment, the interior window 125 is supported by a retaining mechanism 165 that can be released to allow the interior window 125 to swing inward on the hinge 155. In particular, the retaining mechanism 165 may be a screw 170 that abuts the interior pane 125 and can be tightened and loosened to retain or release the interior pane 125. Other types of retaining mechanisms may also be used, including catches, clamps, or the like.

The window system 100 is intended to provide greater protection in the event of impacts. For example, in the case of objects that may be thrown at the window by the wind, dropping from height, or being release from another piece of equipment or the like. In the case of any impacts, the air gap 135 between the panes 120, 125 provides a separation between the panes 120, 125. The separation between panes 120, 125 is expected to provide additional protection in that the air gap 135 assists in stopping propagation of cracks initiated in the exterior pane 120 from continuing through the next pane, in this embodiment, the interior pane 125.

In a particular example from the forestry industry, it has been estimated that the thickness of monolithic polycarbonate needed to stop chain shot would be 1.25 inches (31.75 mm). This is estimated to be similar to the size needed to meet UL/ANSI 752 level 1 bullet proof testing. In a test, an embodiment of a dual pane window having two 0.5 inch (12.7 mm) polycarbonate panes and an air gap of 30 mm was able to pass the UL/ANSI 752 level 1 test.

While embodiments of the improved window system as described herein have not been tested with regard to chain shot as yet, the results of the UL/ANSI test are believed to indicate that the window system will also provide greater protection against chain shot. In particular, the air space between the panes is expected to stop the propagation of the melted pool and prevent a second melted pool from forming in the second pane because the heat of the pool will be reduced/dispersed in the air gap.

In the above embodiment, the focus is on a two-pane window but it will be understood that additional panes and air gaps may also be used. In some multi-pane cases, some panes may be placed adjacent each other without an air gap as long as there is at least one air gap in the window system. Further, the size of the panes described and the air gap between panes has been discussed but suitable sizes can be determined based on the application. Further, the thickness of each of the panes and the air gap provided may generally be determined based on testing against an approved test such as the UL/ANSI 752 level 1 bullet proof test or the like as may be established from time to time. As long as the window system meets the appropriate standard, embodiments of the multi-pane window system herein may have panes with a thickness of 5 mm, 10 mm, 20 mm, 30 mm or any measurement between these. The air gap(s) may be 5 mm, 10 mm, 15 mm, 20 mm, 25 mm, 30 mm or any measurement between these. In some embodiments, in addition to the considerations above, the minimum air gap may be determined by the minimum size needed to allow conditioned air to flow between the panes in order to reduce or prevent fogging or icing.

The use of multiple monolithic panes together with air gaps is also intended to provide some additional benefits. For example, when working with thicker materials, it can be difficult to form the materials into curved or bent shapes. This is particularly true for polycarbonate. By using multiple panes, each pane remains thinner and can still be formed at reasonable cost. For example, a pane of polycarbonate of up to about 15 mm can be curved economically. As such, the use of two panes allows for the polycarbonate to be curved more cost effectively but still provide the level of protection of the thicker single pane that is more difficult/costly to curve. A similar consideration may also apply to the concept of using laminated materials for the window panes because it can be difficult and/or costly to form thicker laminated materials into curved or bent shapes.

In an embodiment of fabricating embodiments of the window system herein, the window panes would first be formed to have a curved shape using known cost effective systems. The panes will then be mounted to provide an air gap between at least two panes.

The above embodiments relate to a multi-pane window system in which an interior pane can be moved to allow cleaning. In other embodiments, the panes may be stationary.

Although the present disclosure has been illustrated and described herein with reference to various embodiments and specific examples thereof, it will be readily apparent to those of ordinary skill in the art that the elements of the embodiments may be combined in other ways to create further embodiments and also other embodiments and examples may perform similar functions and/or achieve like results. All such equivalent embodiments and examples are within the spirit and scope of the present disclosure as defined by the claims.

In the preceding description, for purposes of explanation, numerous details may be set forth in order to provide a thorough understanding of the embodiments. However, it will be apparent to one skilled in the art that these specific details may not all be required. In other instances, well-known structures may be shown in block diagram form in order not to obscure the understanding.

1. A protective window system for non-military heavy equipment comprising at least two window panes of transparent material separated by an air gap.

2. A protective window system according to claim 1, wherein the transparent material is polycarbonate.

3. A protective window system according to claim 1, wherein the thickness of each window pane and the size of the air gap is determined such that the window system meets or exceeds UL/ANSI 752 level 1 testing.

4. A protective window system according to claim 2, wherein each window pane is between 5 and 30 mm thick and the air gap is between 5 and 50 mm.

5. A protective window system according to claim 1, wherein the at least two window panes comprises a plurality of window panes.

6. A protective window system according to claim 1, wherein the air gap comprises a plurality of air gaps.

7. A protective window system according to claim 1, further comprising a channel for transporting conditioned air and a vent for allowing the conditioned air to enter the air gap.

8. A protective window system according to claim 1, further comprising a hinge mechanism for allowing at least one of the at least two window panes to move in relation to another of the at least two window panes.

9. A method of fabricating a protective window system for non-military heavy equipment, the method comprising:
forming at least two window panes to have a curved shape;
mounting a first pane of the at least two window panes on an exterior of a cab of the heavy equipment;
mounting another pane of the at least two window panes on an interior of the cab; and
providing an air gap between at least two of the at least two panes,
wherein at least one of the first pane and another pane are configured to rotate away from the other to allow for cleaning.

10. A method according to claim 9, wherein the thickness of each window pane and the size of the air gap is determined such that the window system meets or exceeds UL/ANSI 752 level 1 testing.

11. A method according to claim 9, wherein each window pane is between 5 and 30 mm thick and the air gap is between 5 and 50 mm.

12. A method according to claim 9, wherein the at least two window panes comprises a plurality of window panes.

13. A method according to claim 9, wherein the air gap comprises a plurality of air gaps.

14. A method according to claim 9, further comprising providing a channel for transporting conditioned air and a vent for allowing the conditioned air to enter the air gap.

15. A protective window system for non-military heavy equipment comprising:
at least two window panes of polycarbonate, formed with a curved shape;
an air gap between at least two of the at least two window panes;
a channel for transporting conditioned air and a vent for allowing the conditioned air to enter the air gap; and
a hinge mechanism for allowing at least one of the at least two window panes to move in relation to another of the at least two window panes,
wherein the thickness of each window pane and the size of the air gap is determined such that the window system meets or exceeds UL/ANSI 752 level 1 testing.
